(19) United States
(12) Patent Application Publication
(10) Pub. No.: US 2007/0247590 A1
(43) Pub. Date: Oct. 25, 2007

(54) Autostereoscopic Multi-User Display with Directed Illumination

(75) Inventor: Armin Schwerdtner, Dresden (DE)

Correspondence Address: SYNNESTVEDT LECHNER & WOODBRIDGE LLP, P O BOX 592, 112 NASSAU STREET, PRINCETON, NJ, 08542-0592, US

(73) Assignee: SEEREAL TECHNOLOGIES GMBH, Dresden (DE)

(21) Appl. No.: 11/573,490

(22) PCT Filed: Jan. 24, 2005
(86) PCT No.: PCT/DE05/00139

§ 371 Date: Feb. 9, 2007

(30) Foreign Application Priority Data
Aug. 10, 2004 (DE) 10 2004 038 676.5

(51) Int. Cl. G03B 21/00

(52) U.S. Cl. 353/7

(57) ABSTRACT

The invention relates to autostereoscopic multi-user displays with a sequential representation consisting of a sweet-spot unit and an image matrix. The sweet-spot unit, configured from an illumination and focusing matrix and positioned in front of the image matrix, focuses approximately parallel light bundles in sweet spots onto the eyes of observers. The aim of the invention is to achieve, by optical means, a tracking with a clear image allocation for observers located at a lateral distance from one another that is less than the distance between the eyes. The freedom of movement in terms of the display should be maintained and the information that is assigned to each observer should remain private with regard to other users. To achieve this, the sweet spots are limited horizontally and vertically with the aid of a focusing matrix, which consists of two crossed lens arrays L1 and L2, or a two-dimensional lens array comprising lenses that are arranged in a matrix, or a double lens array. Said focusing matrix forms a sweet-spot matrix comprising two-dimensionally limited sweet-spot pairs, which contain all controllable observer positions. Autostereoscopic displays of this type can be used in a 2D and/or 3D mode.

This invention relates to a sweet-spot image separating device for autostereoscopic multi-user displays, which represent the stereoscopic information time-sequentially in two or more perspectives for one or several viewers. Autostereoscopic multi-user displays here consist of a sweet-spot unit and an image matrix as information display. The sweet-spot unit contains, arranged one after another in the direction of light propagation, an illumination matrix and a focusing matrix and serves to focus the display contents of the image matrix at the viewer eyes in the form of sweet-spots. In order to enable an image information to be seen stereoscopically, the left/right image contents provided for the left/right eyes of the viewers must be supplied to the left/right eyes with as little cross-talk as possible. The means satisfying this demand is also known as an image separating device and is realized in this invention by an illumination matrix and a focusing matrix configured according to this invention. No other aids such as spectacles or the like are required of the viewer/s when using autostereoscopic displays. Tracking allows the viewers to move independently of each other in a certain viewing space in lateral and normal directions to the display without losing the stereoscopic image impression. Beyond it, a sweet-spot creates a certain scope of movement without taking up the tracking. Alternatively, tracking can be performed with wider tolerances. The stereoscopic information can be represented on a display with temporal or spatial interleaving.

With untracked autostereoscopic displays with two spatially interleaving views, as a rule, a viewer can see a stereo image without cross-talking only if his or her eyes are located exactly at those positions where the stereoscopic information can be perceived. These positions are also known as sweet-spots. To have to remain at these positions for a period of time is mostly felt to be inconvenient. Therefore a variety of solutions have been proposed to enlarge these spots (regions of visibility) as also in the applicant's patent application DE 103 40 089, for example.

With tracked autostereoscopic displays a viewer can move without losing the stereo impression. For this, a position finder determines the viewer's movement and tracks the sweet-spots. Aside from the lateral movement of the viewer also his or her normal distance to the display can be detected. A respective solution for tracking is known, for example, from printed U.S. Pat. No. 6,014,164.

For the exact focusing of the light at the viewer eyes not only in the lateral direction but also for different distances of viewers to the display, in WO 03/053072 A1, for example, a three-dimensionally positionable backlight is disclosed. It is described in different configurations such as LCDs arranged one after another or reflecting addressable surfaces. These light sources addressable in a 3D-backlight are projected by a lens in a projection system onto the eyes of one or several viewers and tracked according to their movements. On its way to the viewers the light passes a light modulator, which offers in time-sequential mode the left image of one or several 3D-programs to the left viewer eyes and the right image of such programs to the right viewer eyes. A disadvantage of this method is the great depth of the autostereoscopic display due to the three-dimensional backlight and the projection lens having an extremely large diameter. In order to limit the aberrations of such large lenses in the region outside the optical axis, the focal distance and hence, the depth of the device must be dimensioned sufficiently large. Further, the device is very heavy and the three-dimensionally positionable backlight is difficult to manufacture.

In printed EP-B-0773 462 a stereoscopic arrangement is described that specifically provides a single viewer with a stereo information on a display. This is achieved by the arrangement of two lenticular arrays on the viewer side of the display, between which a prism mask is arranged. The angles of single prisms of the prism mask vary from column to column from the edge to the center just as the radii of the individual lenses of the lenticular arrays do, whereby each individual element of the lenticular arrays or the prism mask, respectively, covers one pixel pair. Light absorbing means and suitable distances of the individual lenses and prisms to each other make possible that the right and left images reach the viewer and that only from his or her position information can be seen stereoscopically. This solution very precisely provides one single viewer with information, but cannot be used for several viewers as focusing is in only one direction. During the production of this display very accurate adjustment is necessary because of the number of individual dimensions of the individual lenses of the lenticular arrays, prisms and light absorbing means.

A stereoscopic display according to EP 1 102 106 enables at least two viewers to see each a different stereoscopic image in 2D- or 3D-mode at the same time and independently of each other. Here, for example, an illumination arrangement is included such that a light source pair in each case is projected onto the eyes of a given viewer over an optical unit and synchronously to that, the respective image pair is shown on a display line by line. The image pairs are represented on the display by a combination of temporal and spatial interleaving. When the viewers change their positions, different light source pairs are switched on according to the determined positions. Thus they can move and always see the image information chosen. Reduced resolution in the vertical direction and high adjustment efforts are disadvantages of this arrangement. Another disadvantage is the low light efficiency due to addressing of both images in alternating lines, which means splitting of the light in the vertical direction.

It is a general disadvantage of tracked autostereoscopic displays that for faster movements of a viewer the latency times of the position finder and the tracking system frequently cause cross-talking. Also it is generally not taken into consideration that the distances of the eyes may be different for different viewers.

In printed WO 99/05859, among other things, an arrangement for the simultaneous representation of different images, or programs, respectively, for several viewers on one display is described. Each viewer can see his or her images without mutual impairment of the individual representations. For that, a separate image matrix with an accompanying projection unit is firmly assigned to each viewer, whereby the matrices and the projection units in each case have a fixed distance to each other. The images projected into the image plane all appear on the same display and can each be seen by a viewer from his or her position only, whereby he or she has a certain extent of viewer mobility. Spatial separation of the image pairs of a 3D-image, which can be seen stereoscopically in a relatively wide viewing area, can also be achieved using shutters in the projection unit. Using the arrangements described here multiple larger viewing areas being independent of each other can be created for 3D-images, which do not mutually impair each other. A disadvantage is the relatively high effort of optical and other components, which additionally prevent the display from being designed flat. For each viewer, for example, one image matrix with a projection system and a shutter mechanism is needed.

In the prior patent application DE 103 39 076.6 the applicant proposed a solution for the enlargement of the range of movement and the eye distance as well as for the widening of the tolerance of the position change and tracking reaction by the combination of an image matrix as information display with a so-called sweet-spot unit, which includes an illumination matrix and a focusing matrix. The sweet-spot unit is seen in the direction of light propagation located before the image matrix separated from this matrix by function and design. The sweet-spots are created at positions of viewer eyes and have a horizontal extension the magnitude of which advantageously corresponds to the distance of the eyes. The vertical extension of the sweet-spots follows from the column projection of the openings and is not limited. The magnitude of the sweet-spots reduces the high requirements of the tracking accuracy established otherwise. In addition, several viewers can be detected at the same time and can be applied with sweet-spots independently of each other. This makes it possible for multiple viewers independently of each other to see the same or different image sequences, or programs, respectively. True multi-user capability is achieved by this configuration of the display.

With the known autostereoscopic displays the region of visibility of information is confined in the horizontal direction. Therefore, a disadvantage opens up as soon as two or more viewers stay very close to each other. If one viewer, for example, sits and another viewer stands behind him or her, the extended vertical sweet-spots cause overlaps of the image information for the individual viewers, or either can see the information of the other, respectively, although in partially reduced or pseudoscopic quality. Therefore, in order to confine the image information as exactly as possible to the selected viewer, it is necessary to limit the region of visibility of the presented information also in the vertical direction.

Therefore, the invention is intended to obtain for autostereoscopic multi-user displays in flat design by suitable optical means a tracking effect with unambiguous image assignment also for viewers who have a lateral distance with respect to each other smaller than the eye distance. The freedom of each individual viewer to move in lateral and normal directions relative to the display should not be confined and high image quality should be ensured for each individual viewer of a viewer group in his or her chosen program and representation mode as well as mutual non-viewability of the respective information.

According to the invention the problem is solved such that a sweet-spot is confined also in the vertical direction. For this, a focusing matrix is used that optionally consists of two lenticular arrays L1 and L2 arranged crosswise or a two-dimensional lens array with matrix-like arranged lenses or a double lens array of two two-dimensional lens arrays with matrix-like arranged lenses, which causes to develop in the viewer plane a sweet-spot matrix with two-dimensionally confined sweet-spot pairs for right and left viewer eyes which contains all controllable viewer positions.

An essential feature of the lenticular arrays L1 and L2 arranged crosswise as the focusing matrix consists in that their front focal lines are substantially in the plane of the illumination matrix. In order to obtain the smallest possible aberrations, the parallel arranged image elements of the crossed lenticular arrays L1 and L2 each point with their lens vertices in direction of the light propagation. Another embodiment of the focusing matrix provides that the vertices of the parallel arranged image elements of the crossed lenticular arrays L1 and L2 can be opposite to each other.

Instead of a simple two-dimensional lens array also a double lens array consisting of two two-dimensional lens arrays can be used. The lenses of the lens arrays each have a planar and a convex side. Advantageously with respect to low reflection and good compactness, the lenses of both lens arrays face each other with their convex surfaces. Manufacture will be facilitated, if the lenses of the lens arrays have identical dimensions. Individual lenses of the lens arrays can also have different dimensions to repair aberrations or for other optical reasons. Further improvement of the multi-user display with respect to the compensation of aberrations and avoidance of cross-talking is achieved by the combination of the crossed lenticular arrays, the single lens array or the double lens array with a field lens in the focusing matrix. Preferably, the lenticular array can form a functional unit together with the field lens. Economic production of the crossed lenticular arrays or lens arrays is, for example, also possible because they are a compact assembly.

Further, it is provided according to the invention that the matrix-like arranged lenses of the two-dimensional lens array or the double lens array are controllable with respect to their optical properties such as the focal length. This measure enables position changes of at least one viewer to be easily corrected in a variety of directions.

Other embodiments of multi-user displays provide that the focusing matrix is combinable with an illumination matrix which is located in the preferably substantially com- mon focal plane of the lenticular arrays L1 and L2 or the two-dimensional lens array or the double lens array, respectively. The illumination matrix itself can be configured differently. It can consist of a backlight and a shutter with controllable line- or matrix-shaped openings, whereby at least one opening for each projection element of the lenticular arrays or the lens array, respectively, is provided in the shutter. It can also be an active light-emitting component with structures optionally controllable so as to place an intensity arranged in a line- or matrix-shaped arrangement. Particularly, an OLED-display can advantageously be used here as an illumination matrix. This enables the technical effort to be reduced and the projection quality of an autostereoscopic multi-user display to be improved.

Further the illumination matrix can be a projection arrangement in the form of a DLP-component or configured as a similarly suitable design. The technical effort and function of the 3D-representation are simplified significantly, if identical LCD-panels are used for the illumination matrix and the image matrix, the matrices of which only differ by the color or black-and-white mode.

The sweet-spot image separating device for an autostereoscopic multi-user display is represented in examples of embodiments and will be described in greater detail in the following. The accompanying drawings are

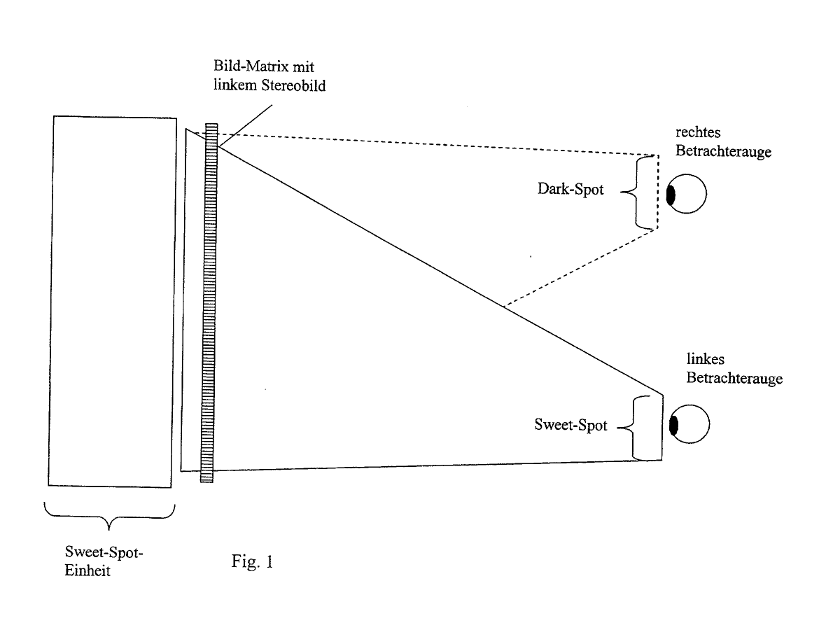

FIG. 1 the top view of a representation of the principle of an autostereoscopic multi-user display consisting of a sweet-spot unit and an image matrix for one viewer;

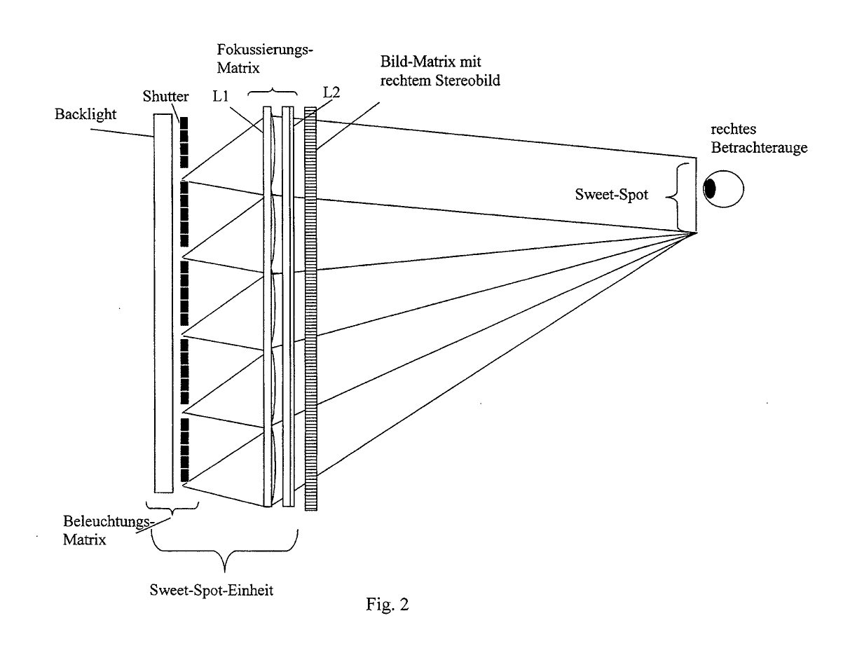

FIG. 2 the top view of a schematic representation of the sweet-spot unit consisting of an illumination matrix and a focusing matrix for the generation of a sweet-spot for a right viewer eye;

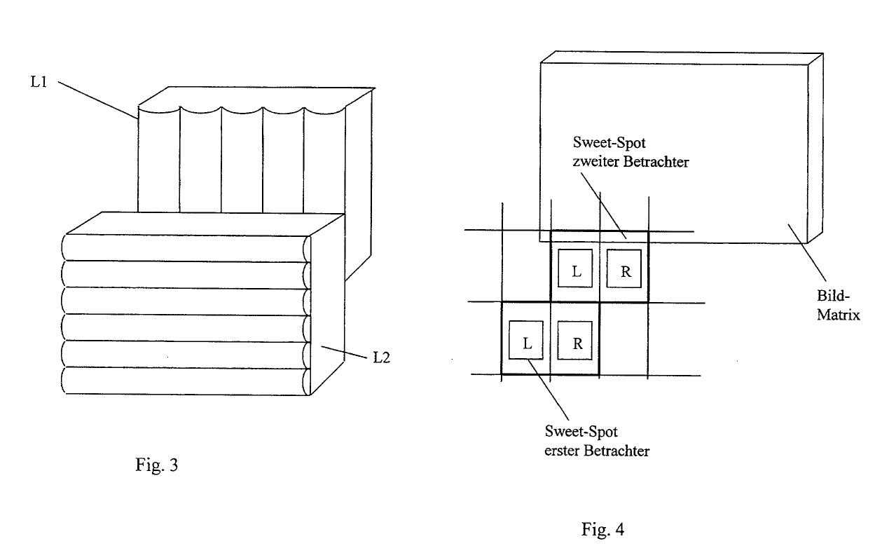

FIG. 3 the top view of a schematic representation of a focusing matrix in the form of crossed double lenticular arrays;

FIG. 4 the top view of a schematic representation of regions of stereoscopic visibility in the form of sweet-spots for right and left eyes of two viewers created in the viewer plane;

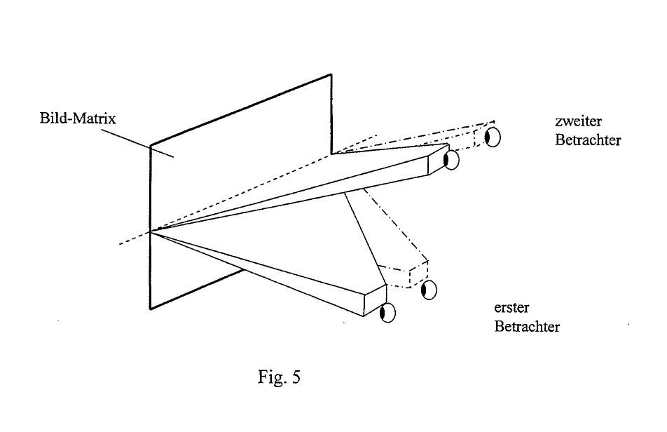

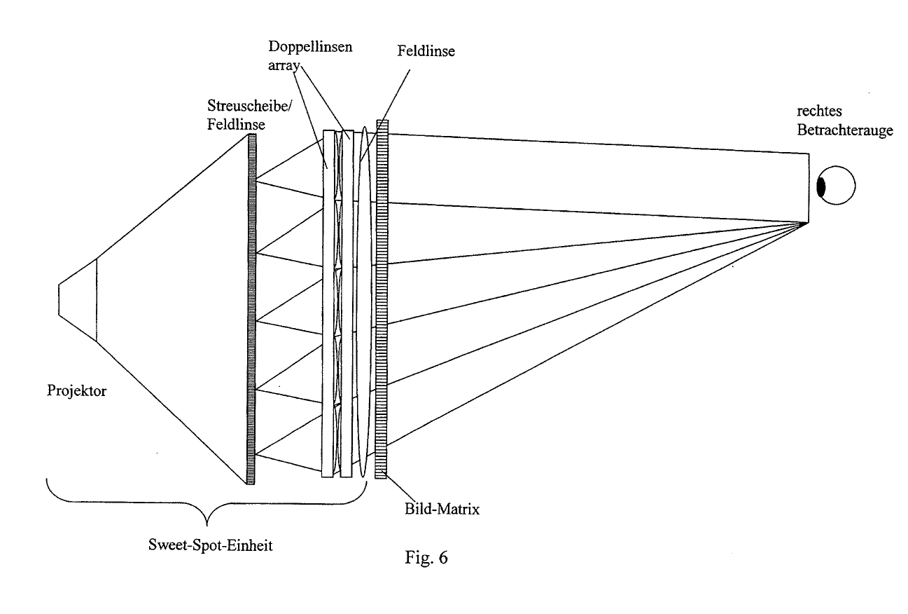

FIG. 5 the top view of a perspective representation of the cones of light for two viewers at different vertical and/or horizontal positions for one image line as created by the sweet-spot unit; and

FIG. 6 the side view of a schematic representation of another embodiment with a lens array as the focusing matrix with horizontal and vertical focusing and a projection arrangement as the illumination matrix.

The autostereoscopic multi-user display according to FIGS. 1 to 6 is based in the stereo mode on tracking of the viewers by means of a sweet-spot unit. The stereo information is shown to the viewers in successive frames, i.e. time-sequentially. This representation of the stereo information is also used in displays with shutter- or polarization spectacles and is widespread. By use of time-sequential methods for auto-stereoscopic multi-user displays, the resolution of the display is maintained and is not reduced by a factor that represents the number of perspectives, as it would be in the case with the spatial multiplex method. The resolution of the image matrix is equal to the resolution of the display used.

FIG. 1 shows the design principle of an autostereoscopic multi-user display in 3D-mode for one viewer. Successively arranged in the direction of light propagation, there are the sweet-spot unit and the information-carrying image matrix as major components. The sweet-spot unit generally consists of an illumination matrix and a focusing matrix, the lenses of which focus the light coming from the illumination matrix in parallel bundles of rays in sweet-spots at one or several selected viewer eyes in the viewer plane.

If a viewer moves laterally or changes his or her distance to the display, each sweet-spot follows the eyes located by the position finder via tracking. The magnitude of the sweet-spot enables the viewer to see stereoscopically, undisturbed, without sweet-spot tracking becoming necessary.

Here in FIG. 1 the image matrix at the instant shown contains the stereo image for the left eye of a viewer and synchronously with that a two-dimensional sweet-spot is directed towards this eye. For the right eye the sweet-spot is blanked at the instant of projection and is referred to as the dark-spot. In an analogous way the right eye is subsequently provided with the right stereo image and correspondingly a dark-spot is switched for the left eye. If the image information of the image matrix is provided for the right and left eye with synchronized focusing of the sweet-spots at the right and left eye sufficiently quickly, the eyes can no longer resolve the provided 2D-image information with regard to time. The viewer then sees the image information stereoscopically without cross-talking. Preferably both the black-and-white panel used as a shutter for the illumination matrix and the information-carrying panel are configured identically except for the color matrix, which significantly simplifies design and function of the multi-user display.

The focusing matrix up to now used in known display arrangements consists of a lenticular array with cylindrical lenses arranged in parallel in the vertical direction. A viewer's position is detected and adequate openings of the illumination matrix are activated columnwise. The rays coming from the illumination matrix fall upon this lenticular array. The optical action of the vertically arranged cylindrical lenses creates a horizontally confined region that can be assigned to a right or left eye position of a viewer. The rays of light pass on their way to the viewer the image matrix and are modulated by said matrix with an adequate right or left image information. From his or her position a viewer can see a stereo image, which is limited only horizontally, but not vertically. For this column activation the viewer has room to move in which the stereo information remains visible for him or her. If adjacent to or just behind him or her there is a second viewer on a different eye level, then their information overlaps because of the missing vertical limitation and neither of them can correctly perceive the stereo images assigned to either of them.

A more detailed schematic representation of FIG. 1 with the arrangement of an illumination matrix connected with a two-dimensional focusing matrix according to this invention for the generation of a sweet-spot for a viewer eye is shown in FIG. 2. In this embodiment the illumination matrix is realized by a backlight and a shutter. Said shutter can be a component acting based on light valves, preferably an LCD, an OLED or an FLCD, or can be realized by a projection arrangement such as a DLP-element (see FIG. 6). In a first embodiment according to the invention the focusing matrix consists of two lenticular arrays L1 and L2 arranged crosswise. Both lenticular arrays L1 and L2 are arranged with respect to each other such that their lens vertices point in the direction of light propagation (see FIG. 3) and therefore produce smaller aberrations for greater viewer angles. The optical parameters of the lenticular arrays are dimensioned such that their focal planes substantially coincide and are located substantially in the plane of the illumination matrix. Alternatively, the lens vertices of both lenticular arrays L1 and L2 can also be located opposite to each other. After the detection of the viewer position, single elements are activated columnwise in the illumination matrix relative to the lenticular array L1. The bundles of rays coming from there are focused horizontally by the first lenticular array L1 of the focusing matrix on the viewer plane. They appear as horizontally limited sweet-spots. Now the action of the crosswise arranged lenticular array L2 adds, in which the image elements are arranged parallel in horizontal direction. The position finder additionally determines at which vertical position the viewer is. According to the result of this determination other openings in the illumination matrix are activated line by line, dependent on the demand. The bundles of rays coming from these openings are focused as vertically limited sweet-spots on the viewer plane by the lenticular array L2 of the focusing matrix. As the focal planes of both lenticular arrays L1 and L2 are substantially in the plane of the illumination matrix, collimation of the bundles of rays is obtained in both the horizontal and vertical directions. In this way stereoscopic image information is created in the viewer plane which is focused in rectangular sweet-spots on viewer eyes.

This is shown by FIG. 4 for two viewers with the rectangular sweet-spots of the viewers highlighted by bold lines. If openings of the illumination matrix situated in front of the crossed lenticular arrays are assigned to said lenticular arrays, a matrix of positions is obtained which can be addressed freely by choice in space of the principal viewer positions. This applies to the horizontal positioning and the vertical positioning as well. The number of said openings of the illumination matrix per projection element (vertical and horizontal cylindrical lens) in the focusing matrix is equal to the number of sweet-spot positions from which the complete image matrix can be seen. Compared with the known solution with sweet-spots (see DE 103 39 076) not limited in the vertical direction, the sweet-spots according to this invention are limited in the viewer plane for two dimensions.

The focusing at viewers or at a preferred distance can be supported by use of a field lens between the focusing and the image matrix. If, for example, the viewers are at a distance equal to the focal plane of a field lens, all identical elements of the illumination matrix belonging to a sweet-spot are activated and the bundles of rays leaving the matrix are parallel to each other. For a sweet-spot on the midpoint of the perpendicular to the image matrix, all these bundles fall normally upon the projection elements of the focusing matrix. In this case the optical aberrations are minimized. If the viewer moves laterally in the focal plane, the angles of the bundles of rays are further equivalent to the deviation from the normal of the image matrix. Also here the angles at which the bundles of rays fall upon the image elements are smaller than without a field lens. A similar consideration applies to a sweet-spot displacement normal to the image matrix.

A schematic perspective representation with a focusing matrix according to the invention is shown in FIG. 5. The path of the light bundles is seen for two viewers at different vertical and/or horizontal positions for an image line in the center of the image matrix. The drawing reproduces the path of the beams in a simplified manner. Naturally all image lines of the display surface are projected onto the viewer eyes. For the first viewer, for example, information in 3D-mode is present. The image matrix contains the left stereo image for this viewer. Simultaneously with the information presentation a sweet-spot for the left eye of the first viewer is created by a suitably programmed activation of the illumination matrix. The second viewer can see with his or her left eye either the same or a different image shown subsequently.

In another example not shown the right eye of a second viewer can be in the same vertical region like the left eye of a first viewer without the second viewer's seeing a wrong image. The crossed lenticular array L2 of the focusing matrix prevents the sweet-spots from overlapping in the vertical direction. The sweet-spots for both viewers are created at different levels and are also vertically limited by the action of the second lenticular array L2 accurately to the respective viewer's eyes, the positions of which have been determined by the position finder. With sufficiently fast presentation of the image information synchronously with the focusing of the sweet-spots, both viewers see the same or different information meant for either of them stereoscopically without cross-talking.

An application of the information presentation using the focusing matrix according to this invention is, for example, conceivable in such a way that a sitting and a standing viewer are present in front of a display, but only one viewer is meant to see the information. Although the second viewer is standing behind the first one, thanks to the additional vertical limitation of the sweet-spot the information remains hidden to him or her.

Another application of the multi-user display is possible when different three-dimensional-image contents are assigned to several viewers who are in the close vicinity of each other. As described for one viewer, suitable sweet-spots are focused one after the other on the eyes of different viewers, while synchronously to that the corresponding stereo images appear successively. Each viewer sees only his or her information, without being affected by the neighbor. Different 2D-image contents can be offered to two or more viewers such that for each viewer the sweet-spots for both eyes are activated for the accompanying 2D-image content.

Thanks to the concentration of the information upon a horizontally and vertically limited sweet-spot, each viewer is free to move horizontally, vertically and normally to the display, without the perception of the stereo information content assigned to him or her being impaired by the neighboring information. The sweet-spot quality and thus the stereo image quality can further be improved such that the optical properties of the focusing matrix are controllable. So the focusing matrix can be continuously adapted, for example, in its focal length to a positional change in normal direction and hence also to a curvature of the image field.

In FIG. 6 the side view of another example of an embodiment for one viewer is shown. Instead of the illumination matrix with an active shutter, a projection system is used. The focusing matrix can be a two-dimensional lens array or, as here in FIG. 6, a double lens array consisting of two two-dimensional lens arrays with the same action as the combination of the two crossed lenticular arrays. To this end the lens arrays each have a planar surface and a lens surface, whereby the lens surfaces of the lens arrays focus in the horizontal and vertical directions as described in FIG. 2. Both lens surfaces face each other in this example. The bundles of rays aiming from the projector at the viewer create rectangular, horizontally and vertically limited sweet-spots in the viewer position after said position has been determined by the position finder. In connection with a field lens located before the image matrix, aberration correction is achieved, as has already been described. Synchronously with the sweet-spots the image matrix is modulated with the image information. Also this arrangement is applicable to at least two viewers, whereby each viewer is presented with the image information assigned to him or her without said information being disturbed by the sweet-spots of the other viewer.

Further an embodiment is designed such that a diffusing glass or/and a field lens is positioned before the illumination matrix to achieve better homogeneity of the light distribution of the focusing matrix.

An autostereoscopic display established in the described manner with the sweet-spot image separating device permits, aside from its usability in 2D- and/or 3D-modes, multi-user capability, the viewers' freedom to move, real-time capability, high resolution, great brightness and small design depth, characterized by its robustness and the absence of mechanical parts, as well as that it dramatically reduces cross-talking, particularly in the multi-user operational mode. Thanks to its great quality features as to image representation and the low cross-talk for each viewer it is well suited for high-end applications in the fields of medicine, technology, research and development, for the mid-range during video-conference systems and in administration, in financial institutions, insurance companies, and for low-end applications as home displays, for video-phones and many other applications. This invention covers application possibilities which have not been mentioned here although they are based upon the principle of this invention.

1. Autostereoscopic multi-user display with directed illumination, which contains one after another, seen in the direction of light propagation, a sweet-spot unit and a transmissive image matrix, where the sweet-spot unit includes an illumination matrix with switchable openings and a focusing matrix with projection elements, which illuminate the image matrix with light of the openings which are switched on, for the sequential representation of images or image sequences, and where a position finder detects the eves of observers in an observer plane, characterized in that the focusing matrix consists of either two lenticular arrays (L1; L2) which are arranged crosswise, or a two-dimensional lens array with lenses which are arranged in a matrix, or a double lens array of two-dimensional lens arrays with lenses which are arranged in a matrix, said lenses generating a matrix of two-dimensionally limited trackable sweet spots for right and left observer eyes by way of column- and line-wise switching on of openings of the illumination matrix.

2. Autostereoscopic multi-user display according to claim 1, characterised in that the matrix of two-dimensionally limited sweet-spots contains all positions which can optionally be served in space as observer positions.

3. Autostereoscopic multi-user display according to claim 1, characterized in that the front focal lines of the crosswise arranged lenticular arrays (L1; L2) are located substantially in the plane of the illumination matrix.

4. Autostereoscopic multi-user display according to claim 1, characterised in that the lens vertices of the projection elements point in the direction of light.

5. Autostereoscopic multi-user display according to claim 1, characterised in that the vertices of the projection elements oppose each other.

6. Autostereoscopic multi-user display according to claim 1, characterised in that the lenses of the double lens array each have a planar side and a convex side.

7. Autostereoscopic multi-user display according to claim 1, characterised in that individual lenses of the double lens array have different focal lengths.

8. Autostereoscopic multi-user display according to claim 1, characterised in that the crosswise arranged lenticular arrays (L1; L2) or the double lens array are made as a compact assembly.

9. Autostereoscopic multi-user display according to claim 1, characterised in that the focusing matrix is combined with a field lens.

10. Autostereoscopic multi-user display according to claim 9, characterised in that a lenticular array (L2) is connected to the field lens.

11. Autostereoscopic multi-user display according to claim 1, characterised in that the optical properties of the projection elements of the focusing matrix are controllable.

12. Autostereoscopic multi-user display according to claim 1, characterised in that the illumination matrix is substantially arranged in the common focal plane of the focusing matrix.

13. Autostereoscopic multi-user display according to claim 12, characterised in that the illumination matrix comprises of a backlight and a shutter with controllable openings arranged in a line or matrix, and in that at least one opening per projection element is provided in the shutter.

14. Autostereoscopic multi-user display according to claim 12, characterised in that the illumination matrix contains actively light-emitting elements with structures which are optionally controllable as regards position and intensity, and which are arranged in a line or matrix.

15. Autostereoscopic multi-user display according to claim 14, characterised in that it is provided with an illumination matrix that comprises OLEDs.

16. Autostereoscopic multi-user display according to claim 12, characterised in that the illumination matrix is configured as a projection arrangement in the form of a DLP component for the generation of horizontally and vertically limited sweet spots.

17. Autostereoscopic multi-user display according to claim 1, characterised in that the illumination matrix and the image matrix are made of identical LCD panels, whose matrices only differ in that one is operated in the colour and one is operated in the black-and-white mode.
